(19) United States
(12) Patent Application Publication
(10) Pub. No.: US 2008/0029183 A1
(43) Pub. Date: Feb. 7, 2008

(54) TIMBER OF A PALM AND METHOD FOR FORMING THE SAME

(76) Inventor: Shen-Ba Lee, Taichung Hsien (TW)

Correspondence Address: PAI PATENT & TRADEMARK LAW FIRM, 1001 FOURTH AVENUE, SUITE 3200, SEATTLE, WA, 98154, US

(21) Appl. No.: 11/461,299

(22) Filed: Jul. 31, 2006

(51) Int. Cl. B27D 1/00; B27G 11/00

(52) U.S. Cl. 144/348; 144/352

(57) ABSTRACT

A method for forming a timber from a palm has acts of gathering a timber piece from a palm trunk, processing the timber piece into a rectangular cross section, first pressure treatment to the timber piece to reduce a moisture content of the timber piece, drying the timber piece, applying glue into the timber piece in a vacuum condition, second pressure treatment to the timber piece to remove redundant glue from the timber piece, drying the timber piece in a mold under a pressed condition and removing the timber piece from the mold.

### BACKGROUND OF THE INVENTION

1. Field of the Invention

The present invention relates to a timber and a method, and more particularly to a timber from a palm and a method for forming the same.

2. Description of Related Art

Wood is an important material for furniture, buildings or decorations, and is widely used in many fields. To obtain a timber, a tree has to be felled, but this will cause bad influence to ecological environment. In addition, a palm or a coconut palm has some economical values, but the trunk of a palm is useless except serving as fuel material because the trunk of a palm contains waters and fibers. Therefore, the trunk of a palm does not have a solid structure for supporting objects. When a palm is felled, the trunk of the palm cannot be used to serve as a wood timber. In addition, borers or moths easily breed in a decayed palm and destroy the neatness of environment. To process the felled palms is always breaking the palms into pieces, but this is laborious and uneconomical.

To overcome the shortcomings, the present invention provides a method to mitigate or obviate the aforementioned problems.

### SUMMARY OF THE INVENTION

The main objective of the invention is to provide a method for forming a timber from a palm to make a palm trunk useful and having economical value. The method for forming a timber from a palm has acts of:

gathering a timber piece from a palm trunk;

processing the timber piece into a rectangular cross section;

first pressure treatment to the timber piece to reduce a moisture content of the timber piece;

drying the timber piece to further reduce the moisture content of the timber piece;

applying glue into the timber piece in a vacuum condition to fill spaces between fibers in the timber piece with glue;

second pressure treatment to the timber piece to remove redundant glue from the timber piece;

drying the timber piece in a mold under a pressed condition to solidify the glue inside the timber piece; and

removing the timber piece from the mold.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a method for forming a timber from a palm in accordance with the present invention; and

FIG. 2 are operational side views of the method for forming a timber from a palm in FIG. 1.

### DETAILED DESCRIPTION OF PREFERRED EMBODIMENT

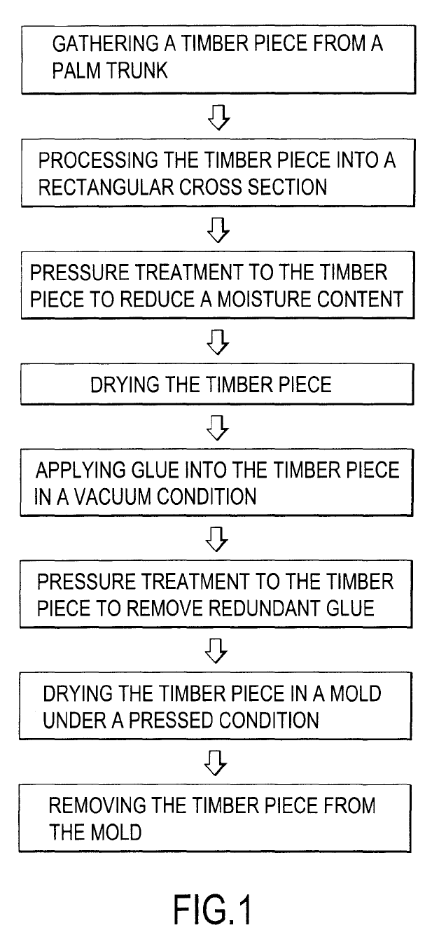

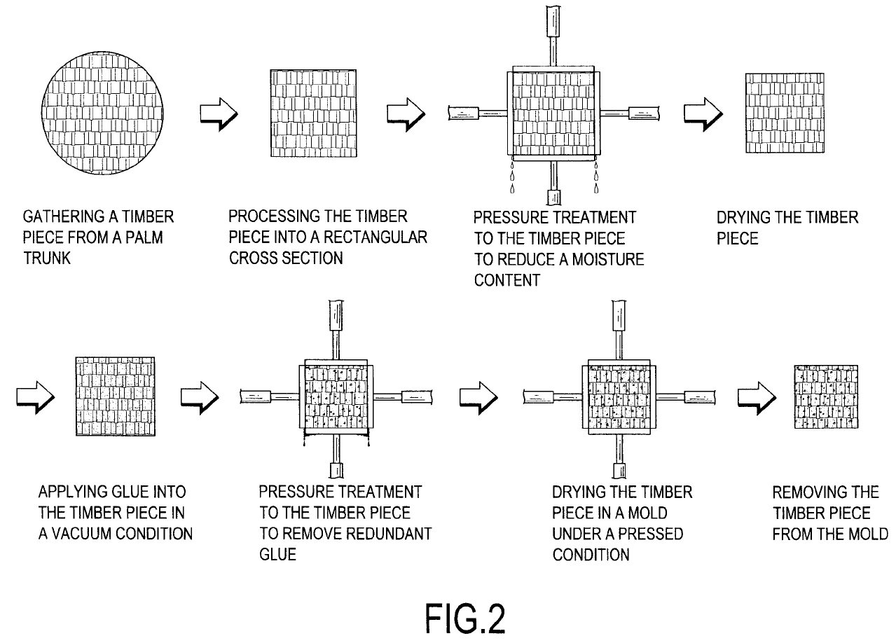

With reference to FIGS. 1 and 2, a method for forming a timber from a palm in accordance with the present invention comprises acts of:

(1) Gathering a timber piece from a palm trunk.

(2) Processing the timber piece into a rectangular cross section.

(3) First pressure treatment to the timber piece to reduce a moisture content of the timber piece. Wherein, the act of first pressure treatment to the timber piece is arranging multiple pressing plates around the timber piece and pressing the pressing plates with multiple cylinders connected respectively to the pressing plates. In a practice, the cylinders are synchronously or asynchronously pressing the pressing plates.

(4) Drying the timber piece to further reduce the moisture content of the timber piece.

(5) Applying glue into the timber piece in a vacuum condition to fill the spaces between the fibers in the timber piece with glue.

(6) Second pressure treatment to the timber piece to remove redundant glue from the timber piece. The redundant glue can be recycled and reused. Wherein, a mold for the act of second pressure treatment to the timber piece comprises multiple pressing plates arranged around the timber piece and multiple cylinders connected respectively to the pressing plates. In practice, the cylinders are synchronously or asynchronously pressing the pressing plates.

(7) Drying the timber piece in a mold under a pressed condition to solidify the glue inside the timber piece. With the pressed drying act, the timber piece can be kept from deformation due to the expansion of the solidified glue. In practice, the mold for drying the timber piece can be same as or different from that for second pressure treatment.

(8) Removing the timber piece from the mold to obtain a timber from a palm.

With such a method, a timber from a palm is achieved. With applying glue into the timber piece, the timber from a palm has an excellent tightness and supporting effect to support an object and can be used for furniture, buildings or decorations. Accordingly, the economical value of a palm is increased, and environment can be kept from being polluted.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for forming a timber from a palm comprising acts of:
gathering a timber piece from a palm trunk;
processing the timber piece into a rectangular cross section;
first pressure treatment to the timber piece to reduce a moisture content of the timber piece;
drying the timber piece to further reduce the moisture content of the timber piece;
applying glue into the timber piece in a vacuum condition to fill spaces between fibers in the timber piece with glue;
second pressure treatment to the timber piece to remove redundant glue from the timber piece;
drying the timber piece in a mold under a pressed condition to solidify the glue inside the timber piece; and
removing the timber piece from the mold.

2. The method as claimed in claim 1, wherein the act of first pressure treatment to the timber piece is arranging multiple pressing plates around the timber piece and pressing the pressing plates with multiple cylinders connected respectively to the pressing plates.

3. The method as claimed in claim 2, wherein in the act of first pressure treatment to the timber piece, the cylinders are synchronously pressing the pressing plates.

4. The method as claimed in claim 3, wherein the act of second pressure treatment to the timber piece is arranging multiple pressing plates around the timber piece and pressing the pressing plates with multiple cylinders connected respectively to the pressing plates.

5. The method as claimed in claim 4, wherein in the act of second pressure treatment to the timber piece, the cylinders are synchronously pressing the pressing plates.

6. The method as claimed in claim 1, wherein the act of second pressure treatment to the timber piece is arranging multiple pressing plates around the timber piece and pressing the pressing plates with multiple cylinders connected respectively to the pressing plates.

7. The method as claimed in claim 6, wherein in the act of second pressure treatment to the timber piece, the cylinders are synchronously pressing the pressing plates.

8. A timber from a palm made by the following acts:
gathering a timber piece from a palm:
processing the timber piece into a rectangular cross section;
first pressure treatment to the timber piece to reduce a moisture content of the timber piece;
drying the timber piece to further reduce the moisture content of the timber piece;
applying glue into the timber piece in a vacuum condition to fill spaces between fibers in the timber piece with glue;
second pressure treatment to the timber piece to remove redundant glue from the timber piece;
drying the timber piece in a mold under a pressed condition to solidify the glue inside the timber piece; and
removing the timber piece from the mold to obtain a timber from a palm.
